(19) United States
(12) Patent Application Publication
(10) Pub. No.: US 2022/0123459 A1
(43) Pub. Date: Apr. 21, 2022

(54) Radome with Reduced Wind Load

(71) Applicant: Nokia Shanghai Bell Co., Ltd., Shanghai (CN)

(72) Inventors: Julien TOUCHET, Perros Guirec (FR); Thomas JULIEN, Lannion (FR); Ronan CHAUME, Cavan (FR); Nicolas ADNET, Trebeurden (FR); Zied CHARAABI, Lannion (FR)

(73) Assignee: Nokia Shanghai Bell Co., Ltd.

(21) Appl. No.: 17/500,027

(22) Filed: Oct. 13, 2021

(30) Foreign Application Priority Data
Oct. 19, 2020 (EP) 20202473.3

(51) Int. Cl. H01Q 1/42

(52) U.S. Cl. CPC H01Q 1/42

(57) ABSTRACT

A radome with reduced wind load is described. An example apparatus includes a radome configured to house an antenna. The radome includes a main body that extends lengthwise from a first end to a second end. The radome also includes an end cap disposed at the first end of the main body. The end cap includes a textured outer surface and corners that are rounded with respect to a vertical plane of the radome.

### TECHNOLOGICAL FIELD

Embodiments of the present disclosure relate to a radome with reduced wind load.

### BACKGROUND

Various types of wireless communications rely on the use of outdoor antenna installations. Such technologies include mobile communications, terrestrial broadcasting, and others. To ensure the mechanical integrity of such installations, the wind load characteristics of the antennas should be taken into account.

### BRIEF SUMMARY

According to various, but not necessarily all, embodiments there is provided an apparatus comprising a radome configured to house an antenna. The radome includes a main body that extends lengthwise from a first end to a second end and an end cap disposed at the first end of the main body. The end cap has corners that are rounded with respect to a vertical plane of the radome. The end cap also includes a textured outer surface.

In some embodiments, the corners of the end cap are rounded to have a radius of at least 10 mm. The corners may also include first corners along a long edge of the end cap and having a first radius and second corners along a short edge of the end cap and having a second radius, wherein the first radius is smaller than the second radius. For example, the first radius may be 10 mm or greater, and the second radius may be 20 mm or greater. In some embodiments, the first radius may be approximately equal to half the length of the short edge, and second radius may be approximately equal to half the length of the long edge. The shape of the end cap may also be that of a half dome.

In some embodiments, the textured outer surface is a plurality of dimples. The textured outer surface may also be a non-uniform pattern. The textured outer surface may be provided by a film adhered to an outer surface of the end cap, or by pressing a pattern into an outer surface of the end cap.

According to various, but not necessarily all, embodiments there is provided a radome with reduced wind load. The radome includes a main body having a vertical length and a cross section comprising a width and a depth. The radome also includes a pair of end caps disposed at opposite ends of the vertical length of the main body to cover openings at a top and bottom end of the main body. At least one of the pair of end caps has a textured outer surface and corners that are rounded with respect to a vertical plane of the radome to have a radius of at least 10 mm.

In some embodiments, the corners include first corners along the width of the end cap and having a first radius and second corners along the depth of the end cap and having a second radius, wherein the first radius is smaller than the second radius. For example, the first radius may be approximately equal to half the depth of the radome and the second radius may be approximately equal to half the width of the radome. In some embodiments, the main body and the pair of end caps include a dimpling pattern disposed on a majority of the outer surface of the main body and the pair of end caps.

### BRIEF DESCRIPTION

Some examples will now be described with reference to the accompanying drawings in which:

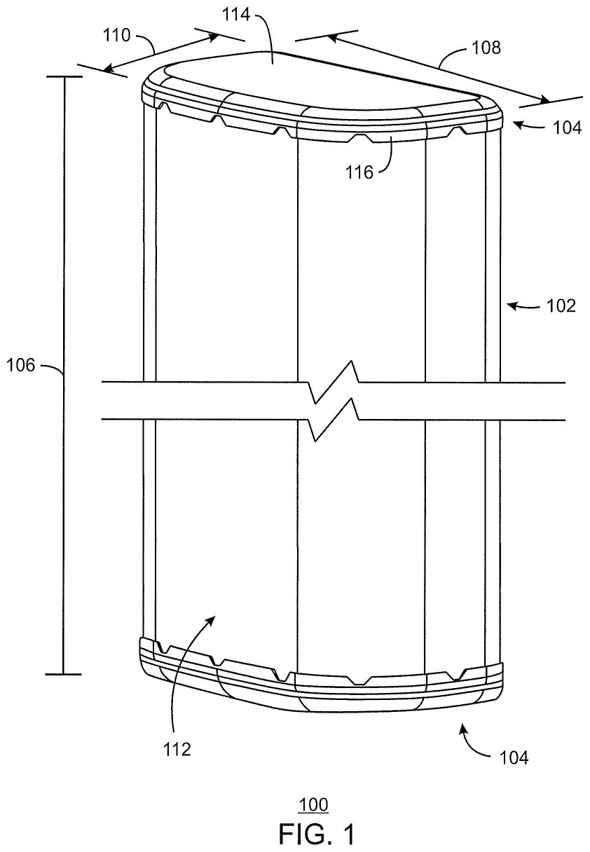

FIG. 1 is a perspective view of an example radome in accordance with embodiments;

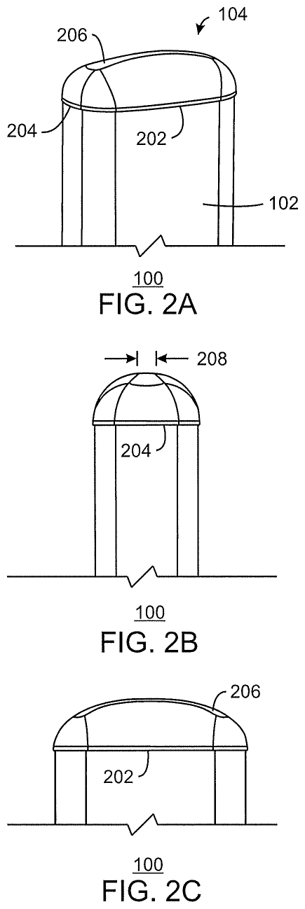

FIGS. 2A, 2B, and 2C show another embodiment of a radome in accordance with embodiments;

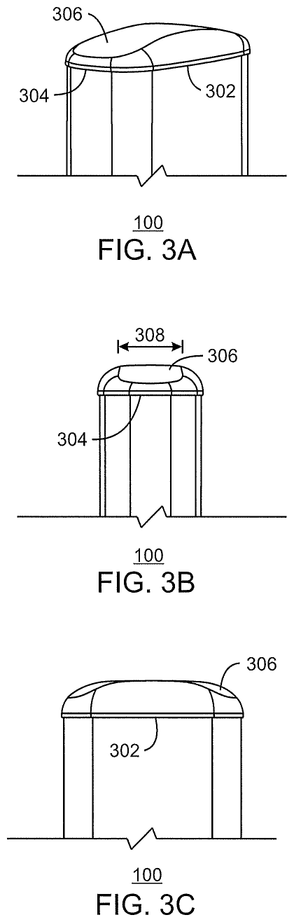

FIGS. 3A, 3B, and 3C show another example of a radome in accordance with embodiments;

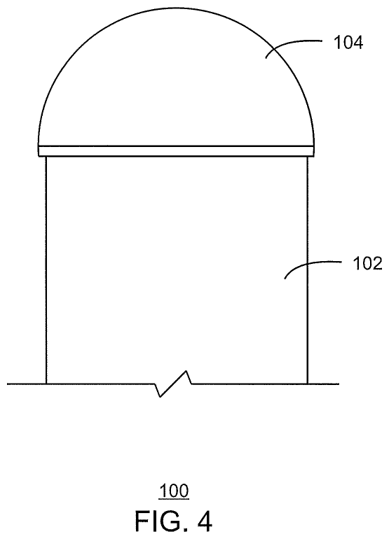

FIG. 4 shows another example of a radome in accordance with embodiments;

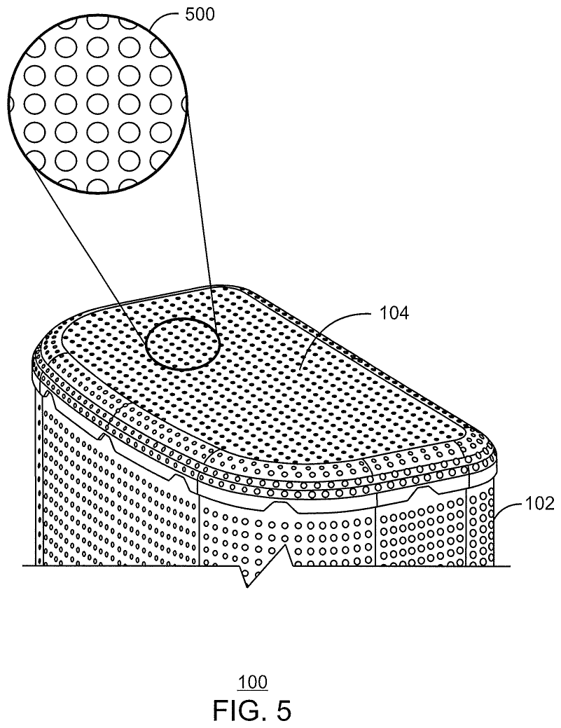

FIG. 5 is a perspective view of the top portion of a radome with a textured surface in accordance with embodiments;

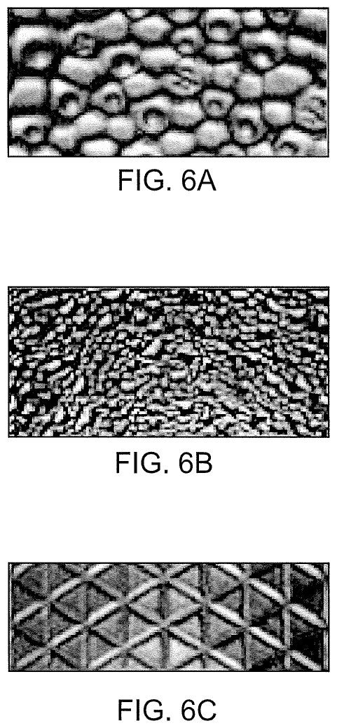

FIGS. 6A, 6B, and 6C show examples of textures that can be applied to the outer surface of a radome in accordance with embodiments;

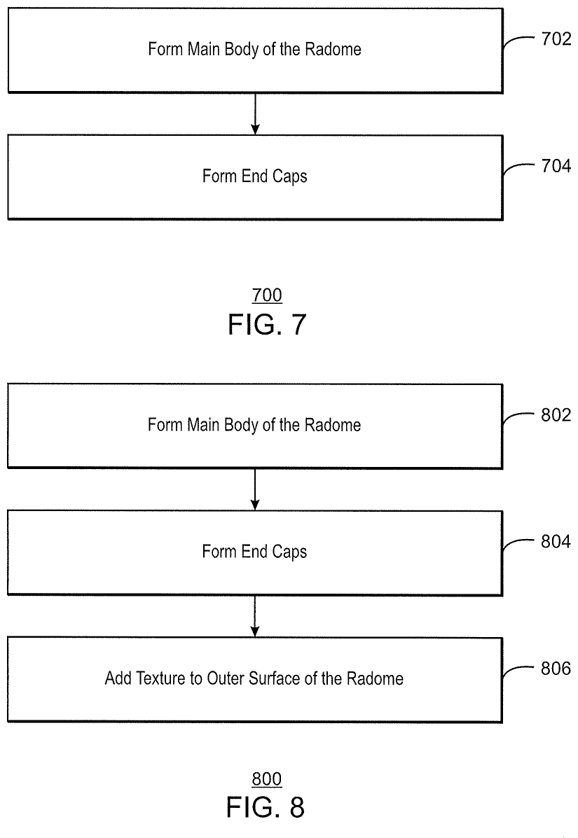

FIG. 7 is a process flow diagram for a method of forming a radome in accordance with embodiments;

FIG. 8 is process flow diagram for another method of forming a radome in accordance with embodiments;

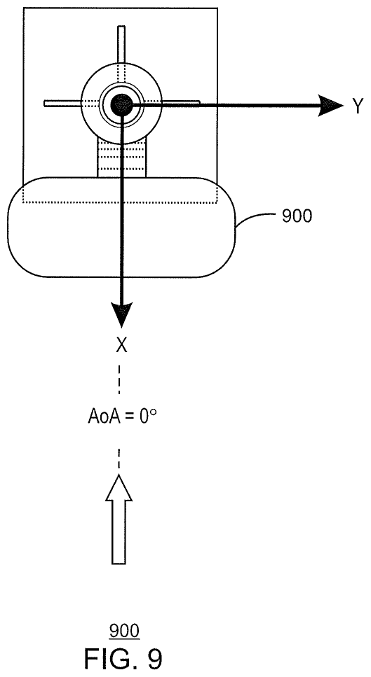

FIG. 9 is a top view of a radome coupled to a support structure;

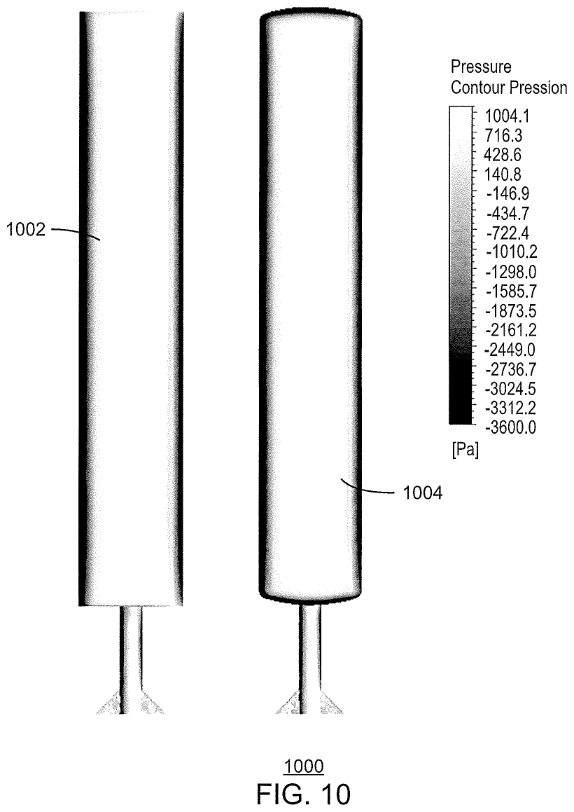

FIG. 10 shows a simulated pressure contour for a pair of radomes;

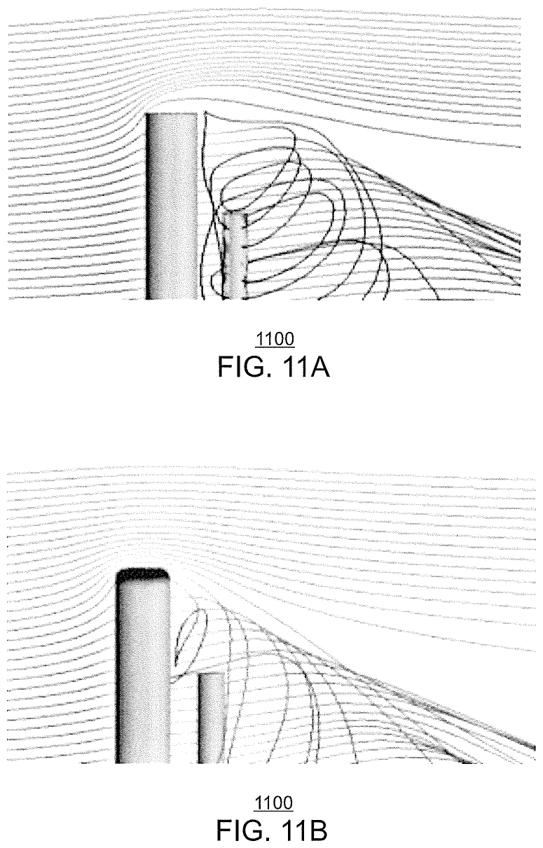

FIGS. 11A and 11B shows simulated wind velocity streamlines for a pair of radomes;

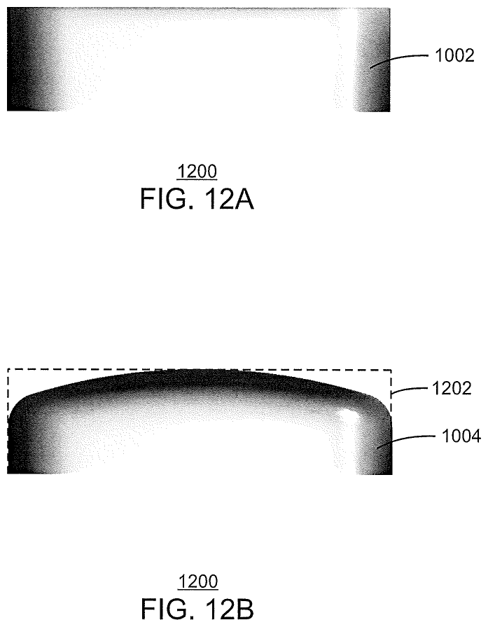

FIGS. 12A and 12B are frontal views of the tops of the radomes shown in FIG. 10 with simulated pressure contours;

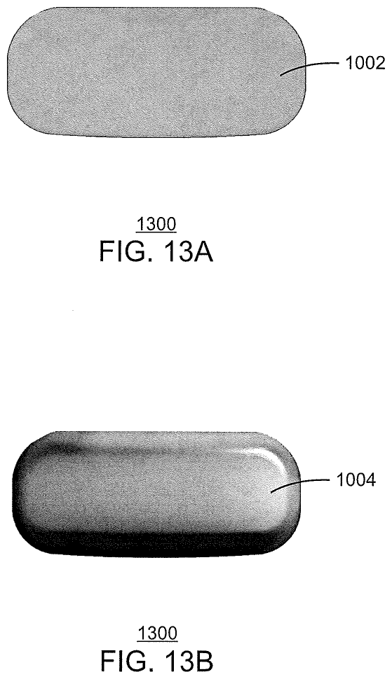

FIGS. 13A and 13B are top views of the radomes shown in FIG. 10 with simulated pressure contours;

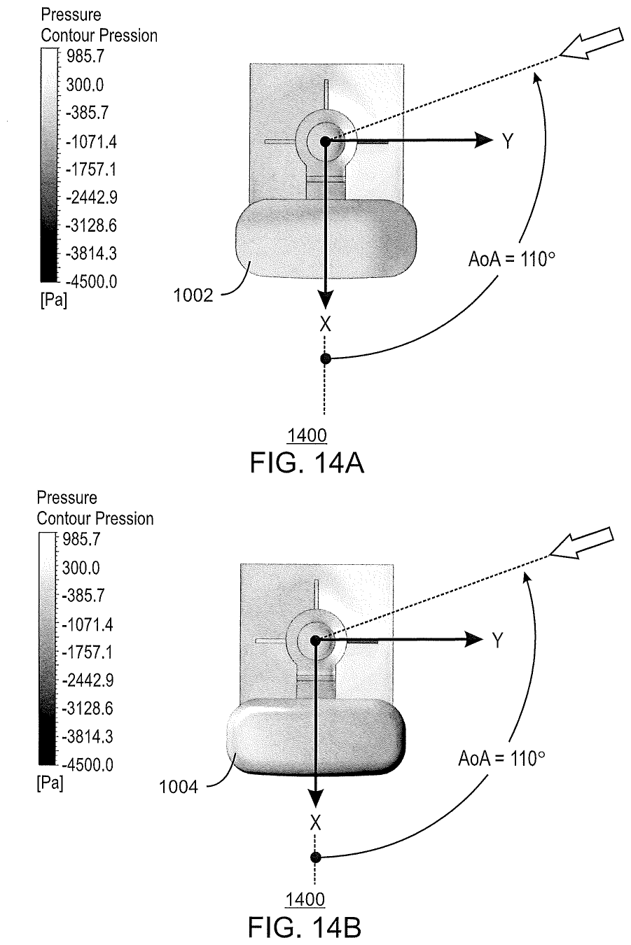

FIGS. 14A and 14B are top views of the radomes shown in FIG. 10 with simulated pressure contours.

### DETAILED DESCRIPTION

The subject matter disclosed herein relates to a radome with reduced wind load. A radome is an outer protective shell disposed around one or more antennas to protect the antennas from damage that could otherwise be caused by outdoor weather conditions. The size and shape of the radome will determine the wind load characteristics of the antenna, which determine the stresses applied to the tower and mounting structures due to wind. Reducing the wind load of the radome improves the structural integrity of the antenna and the tower to which it is attached.

The present disclosure describes techniques for shaping the end caps of a radome to reduce the radome's wind load. In the examples shown and described below, the corners of the end cap may be rounded and the entire end cap may have a curved profile. Wind load can be further reduced by adding a texture to the outer surface of the end cap and the main body of the radome. Embodiments of the present techniques will be better understood with reference to the examples shown below.

FIG. 1 is a perspective view of an example radome in accordance with embodiments. Although not shown, it will be appreciated that the radome 100 is configured to cover one or more antennas. The antennas may be configured for use in any suitable type of wireless communication, including cellular communications, terrestrial television and radio broadcasting, and others. The antenna may also include mounting structures that extend through the radome 100 and enable the antenna to be coupled to a support structure such as cell tower.

As shown in FIG. 1, the radome 100 includes a main body 102 and a pair of end caps 104. The main body 102 and end caps 104 may be made of any suitable material including fiberglass, Polyvinyl Chloride (PVC), Acrylonitrile Styrene Acrylate (ASA), Fiber-Reinforced Plastic (FRP), and others. The main body 102 is elongated and extends lengthwise from a first end to a second end with a substantially constant cross-section along its vertical length 106. The radome's cross section has a width 108 and a depth 110 and is in the shape of a rectangle with rounded corners. However, the cross section of the radome 100 may also be in the shape of a rectangle with sharp corners, an ellipse, a cylinder, and others. The length 106, width 108, and depth 110 of the radome 100 may be any suitable dimension that provides suitable space for the enclosed antenna or antennas. The length of the radome 106 will depend on the frequency of operation of the antenna, the number of antennas, the number of radiating elements per antenna, and other factors. For example, in the case a cellular communications, the radome may be approximately 0.6 m to 2.8 m long. For purposes of the present description, the front 112 of the radome refers to the face of the radome through which the main beam of the antenna passes. Additionally, the vertical plane of the radome 100 refers to any plane that runs parallel to the length of the radome and orthogonal to the radome's cross-section.

The end caps 104 are shaped to fit over the open ends of the main body 102 and may be fixed to the main body 102 by plastic rivets, for example. In the example of FIG. 1, the top end cap 104 and the bottom end cap 104 have the same shape. However, in some embodiments, the end caps 104 at the top and bottom of the radome 100 may be shaped differently.

In this example, the top end cap 104 has a flat top surface 114 and an outer edge 116 that is perpendicular to the top surface 114 and fits over the outside of the main body 102 to form a tight coupling. Rather than having a sharp corner at the interface between the top surface 114 and the edge 116, the corners of the end cap are rounded with respect to the vertical plane of the radome 100. Having rounded corners in the vertical plane reduces the wind load of the radome 100 compared to an end cap with sharp corners in the vertical plane. The rounded corners may have a radius of approximately 10 to 100 mm in the vertical plane. The end caps 104 also have rounded corners in the horizontal plane, the shape of which is dictated by the shape of the main body 102 of the radome. Other example end cap embodiments are described below with reference to FIGS. 2A to 4.

FIGS. 2A, 2B, and 2C show another embodiment of a radome in accordance with embodiments. In this example, the main body 102 of the radome 100 has a rectangular cross-section with rounded corners. Additionally, the end cap 104 is more rounded compared to the end cap of FIG. 1. This is accomplished, at least in part, by increasing the radius of the rounded corners compared to the example of FIG. 1. The end cap 104 has a long edge 202 which coincides with the width of the radome 100 and a short edge 204 that coincides with the depth of the radome 100. The corner radius at the long edge 202 may be approximately 10 to 100 mm, and the corner radius at the short edge 204 may be approximately 10 to 100 mm. Additionally, in this example, the top surface 206 of the radome 100 is a narrow strip that exhibits a slight curve in the direction along the width of the radome 100 but is flat in the direction along the depth of the radome 100. The width 208 of this narrow strip may be approximately 10 to 200 mm. In some examples, the corner radius at the long edge 202 may be equal to half the depth of the radome 100, in which case the narrow strip at the top of the radome may be substantially eliminated.

For the sake of clarity, only the top end cap is shown. It will be appreciated that the bottom end cap can have the same shape as the top end cap. However, it is also possible in some examples for the bottom end cap to be shaped differently. For example, the bottom end cap may have a different curvature profile or may even have a flat bottom with sharp corners.

The shape of the radome 100 and end caps shown in FIGS. 2A-2C may be adjusted based on a variety of factors, including the shape of the main body 102, the size and shape of the antenna system enclosed within the radome, and others. In some cases, determining the overall shape of the end caps 104 to reduce the wind load will involve a tradeoff between reducing the surface area exposed to the wind, and shaping the end caps 104 to improve the aerodynamics of the radome. Other shape variations are described below in relation to FIGS. 3A to 4. However, it will be appreciated that the additional variations are also possible within the scope of the claimed subject matter.

FIGS. 3A, 3B, and 3C show another example of a radome in accordance with embodiments. The example shown in FIGS. 3A-3C is similar to the embodiment shown in FIGS. 2A-2C except that the shape of the end cap 104 has a generally flatter profile. This is accomplished, at least in part, by reducing the radius of the rounded corners along the long edge 302 and the short edge 304. As can be seen in FIG. 3, the corner radius along the short edge 304 is smaller than the corner radius along the long edge 302. In this example, the corner radius at the short edge may be approximately 10 to 50 mm, and the corner radius at the long edge may be approximately 10 to 100. Additionally, in this example, the top surface 306 of the radome 100 is a wider strip that exhibits a slight curve in the direction along the width of the radome 100 but is flat in the direction along the depth of the radome 100. The width of this strip may be approximately 50 to 100 mm.

FIG. 4 shows another example of a radome in accordance with embodiments. In this example, the main body 102 of the radome 100 is cylindrical and the end cap 104 is in the shape of a half dome. In this example, the radius of the half dome is determined by the radius of the main body 102. The length and radius of the radome 100 is determined by the size of the antenna enclosed by the radome 100. In some examples, the radius of the end cap 104 may be approximately 100 to 250 mm. The height of the end cap 104 can allow a portion of the enclosed antenna structure to extend beyond the length of the main body 102 and into the volume enclosed by the end cap 104.

It will be appreciated that the radome shapes and end cap shapes described herein are presented as examples of the present techniques. Various alterations may be made within the scope of the present claims. For example, although reference is made to the radius or a rounded corner, it will be appreciated that the rounded corners can have substantially any type of curvature including circular curves, parabolic curves, and others. Additionally, the curvature of the end cap, including the radius of the rounded corners can be adjusted to any value that reduces the wind load for a particular radome given the physical constraints of the antenna system within the radome. Embodiments of the present techniques also include a radome with a textured surface. Examples of surface texturing for a radome are described in relation to FIGS. 5 to 6C.

FIG. 5 is a perspective view of the top portion of a radome with a textured surface in accordance with embodiments. The radome 100 of FIG. 5 is similar in shape to the radome shown in FIG. 1, except that the outer surface of the radome 100 includes a plurality of dimples. In a radome with a smooth surface, the wind impacting the radome tends to create a large wake, resulting in a high degree of drag. Adding texture to the outer surface of the radome 100 causes the air at the surface of the radome 100 to be more turbulent, which reduces the size of the wake and reduces the resulting drag. As a result, the textured surface can reduce the wind load of the radome 100 compared to a radome with a smooth surface.

As used herein, the terms roughness and surface roughness refer to the deviation of a real surface from its ideal form in a direction normal to the surface. A radome without an added surface texture may have a roughness of approximately 0.0015 mm depending on the type of material. The radome with an added surface texture may have a surface roughness of approximately 0.015 to 0.04. The dimples shown in FIG. 5 may be semicircular depressions in the radome that have a depth of approximately 0.5 to 1.5 mm. The dimples may be approximately 1 to 5 in diameter, with a dimple-to-dimple spacing of approximately 1 to 10 mm. Additionally, although dimples are shown, the texture may also be a plurality of depressions or raised bumps of any suitable shape, including cylindrical, rectangular, and others. The texture may also be a uniform or non-uniform. Additional texture types are shown in FIGS. 6A to 6C.

Although the dimpled texturing is shown as covering both the main body 102 and the end cap 104, the texture can be added to a smaller portion of the radome 100. For example, the texturing can be added to only the end caps 104 or only the main body 102. Additionally, the degree of coverage can vary from what is shown in FIG. 5. For example, the texturing may cover the top surface of the end cap 104, but not the rounded edges. The texturing may cover a majority of the surface area of the main body 102 and/or the end caps 104, including up to 75 percent, 90 percent, or 100 percent of the surface area, for example.

FIG. 6A is another example of texture that can be applied to the outer surface of a radome in accordance with embodiments. The texture shown in FIG. 6A is a non-uniform array of irregular-shaped raised bumps, some of which are pitted. The average diameter of the bumps may range from 0.2 to 2 mm, and provide a roughness of approximately 0.015 to 0.04.

FIG. 6B is another example of texture that can be applied to the outer surface of a radome in accordance with embodiments. The texture shown in FIG. 6B includes a non-uniform set of randomly shaped depressions, which provide a roughness of approximately 0.015 to 0.04.

FIG. 6C is another example of texture that can be applied to the outer surface of a radome in accordance with embodiments. The texture shown in FIG. 6C is a uniform pattern of linear depressions arranged in a lattice pattern. The spacing between parallel lines of the lattice may be approximately 2 to 10 mm. The depth of the depressions may be approximately 0.2 to 1 mm. Additionally, although depressions are shown, the texture may also be formed of raised lines rather than depressions.

It will be appreciated that the textures shown in FIG. 5 and FIGS. 6A to 6C are only examples, and that various other texture types are possible, including combinations of the textures described herein. Furthermore, any of the described textures may be implemented with any of the radome shapes described herein.

In some embodiments, the texturing is formed in the radome material itself. For example, in some embodiments, the main body 102 of the radome may be formed using extrusion while the end caps 104 may be formed using a molding technique. Components formed by extrusion may be textured by printing the pattern into the radome material using a tool that impresses the pattern into the radome material as it leaves the extruder. Components formed by molding may have the texture included in the mold.

In some embodiments, the texture may be added as another material that covers the surface of the radome 100. For example, the texture can be formed in a thin sheet of adhesive film that can be coupled to the outer surface of the radome 100. The film can be flexible to enable the film to conform to curved shapes without wrinkling. Additionally, the film can be shaped to enable it to better conform to curved surfaces without introducing wrinkles.

The texture may also be applied to the surface of the radome as a liquid substance such as an epoxy that dries or cures with a textured surface. Such a substance could be applied to the surface of the radome 100 through spraying coating, for example.

FIG. 7 is a process flow diagram for a method of forming a radome in accordance with embodiments. In this method 700, texture is embedded in the radome material. It will be appreciated the processes shown in block 702 and 704 may be performed in any suitable order, and that the method 700 may also include fewer or additional processed depending on the design considerations of a particular embodiment.

At block 702, the main body of the radome is formed. The main body may be formed by extrusion. In some examples, a texture may be added to the outer surface of the radome by a printing tool that impresses the texture into the radome material as the radome leaves the extruder.

At block 704, the end caps are formed. The end caps may be formed by a molding process. In some examples, the mold may include a texture such as one the textures described herein. Additionally, the end cap may be curved as described herein to reduce the wind load of the radome.

FIG. 8 is process flow diagram for another method of forming a radome in accordance with embodiments. In this method 800, texture is added to the outer surface of the radome as an additional film or substance. It will be appreciated the processes shown in blocks 802 to 806 may be performed in an order different from what is shown, and that the method 800 may also include fewer or additional processed depending on the design considerations of a particular embodiment.

At block 802, the main body of the radome is formed. The main body may be formed by extrusion.

At block 804, the end caps are formed. The end caps may be formed by a molding process. The end caps may be curved as described herein to reduce the wind load of the radome.

At block 806, the texture is added to the outer surface of the radome. The texture may be added to each part individually, or may be added to the assembled radome. The texture may be included in an adhesive film which is adhered to the surface of the main body and/or the end cap. Additionally, the texture may be added by coating the radome with a liquid substance that dries or cures with a textured surface.

FIGS. 9-14 show simulated wind load test results that demonstrate the improved performance of a radome with rounded corners in accordance with embodiments. In the following figures, comparisons are made between a radome that has end caps with sharp corners versus a radome that has end caps with rounded corners.

FIG. 9 is a top view of a radome coupled to a support structure. As shown in FIG. 9, the angle of attack (AoA) is zero degrees. The angle of attack refers to the direction of wind relative to the radome in the horizontal (i.e., azimuthal) plane. In the following description, a zero degree angle of attack means that the wind is directed at the front face of the radome in a direction perpendicular to the front face of the radome. FIGS. 10-13 below present simulated results for a zero degree angle of attack.

FIG. 10 shows a simulated pressure contour for a pair of radomes. The pressure contours show the pressure exerted on the radomes caused by wind with an angle of attack of 0 degrees. The radome 1002 on the left shows results for a radome that has end caps with sharp corners. The radome 1004 on the right shows results for a radome that has end caps with rounded corners. As can be seen in FIG. 10, there is a significant pressure reduction in the area of the end caps with rounded corners. The pressure reduction at the end caps reduces the total surface pressure of about 5 percent.

FIGS. 11A and 11B shows simulated wind velocity streamlines for a pair of radomes. FIG. 11A shows results for a radome that has end caps with sharp corners. FIG. 11B shows results for a radome that has end caps with rounded corners. The velocity streamlines show the flow of air around the radomes and demonstrate the aerodynamic properties of each. For the end cap with sharp corners (FIG. 11A), wind is strongly deflected upward at the end of the end cap, resulting in a wake above the end cap and behind the main body of the radome. For the end cap with rounded corners (FIG. 11B) wind flows more evenly above the end cap and behind the main body of the radome, resulting in a reduced wake size compared to the radome with sharp corners. The reduced wake size reduces the vacuum pressure exerted on the radome due to the wind.

FIGS. 12A and 12B are frontal views of the tops of the radomes shown in FIG. 10 with simulated pressure contours. The overall length of the radomes 1002 and 1004 are the same. Therefore, it will be appreciated that rounding the corners of the radomes as shown in FIG. 12B will reduce the projected area of the radome 1004 compared to the radome 1002 with sharp corners. The dotted line 1202 represents the projected area of the radome 1002 with sharp corners and allows easy comparison of the projected areas. The drag force on a radome can be determined according to the following formula:

F=Q0×Cf×A

where F is the drag force, Q0 is the dynamic pressure, Cf is the drag coefficient, and A is the projected area. Therefore, assuming a conservative drag coefficient, a reduction in the projected area reduces the resulting drag force and wind load.

FIGS. 13A and 13B are top views of the radomes shown in FIG. 10 with simulated pressure contours. The radome 1002 of FIG. 13A shows results for a radome that has end caps with sharp corners. The radome 1004 of FIG. 13B shows results for a radome that has end caps with rounded corners. A comparison of FIGS. 13A and 13B shows that the average pressure over the top of the radome is reduced for the rounded end cap compared to the end cap with sharp corners.

The drag force on a radome can be determined according to the following formula:

F=P×S

where F is the drag force, and S is the surface area. Therefore, assuming a conservative surface area, a reduction in the pressure reduces the resulting drag force and wind load.

FIGS. 14A and 14B are top views of the radomes shown in FIG. 10 with simulated pressure contours. The pressure contours shown in FIGS. 14A and 14B, are simulated for an angle of attack of 110 degrees. The radome 1002 of FIG. 13A shows results for a radome that has end caps with sharp corners. The radome 1004 of FIG. 13B shows results for a radome that has end caps with rounded corners. A comparison of FIGS. 14A and 14B shows that, even at a different angle of attack, the average pressure over the top of the radome is reduced for the rounded end cap compared to the end cap with sharp corners.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims. For example, features described in the preceding description may be used in combinations other than the combinations explicitly described above. Additionally, although functions have been described with reference to certain features, those functions may be performable by other features whether described or not. Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasize an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

While endeavoring in the foregoing specification to draw attention to those features believed to be of importance, it should be understood that the Applicant may seek protection via the claims in respect of any patentable feature or combination of features hereinbefore referred to and/or shown in the drawings whether or not emphasis has been placed thereon.

1. An apparatus comprising:
a radome configured to house an antenna, the radome comprising:
a main body that extends lengthwise from a first end to a second end; and
an end cap disposed at the first end of the main body, wherein the end cap comprises corners that are rounded with respect to a vertical plane of the radome, and wherein the end cap comprises a textured outer surface.

2. The apparatus of claim 1, wherein the corners are rounded to have a radius of at least 10 mm.

3. The apparatus of claim 1, wherein the corners comprise:
first corners along a long edge of the end cap and having a first radius; and
second corners along a short edge of the end cap and having a second radius;
wherein the first radius is smaller than the second radius.

4. The apparatus of claim 3, wherein the first radius is 10 mm or greater, and the second radius is 20 mm or greater.

5. The apparatus of claim 3, wherein the first radius is approximately equal to half the length of the short edge.

6. The apparatus of claim 3, wherein the second radius is approximately equal to half the length of the long edge.

7. The apparatus of claim 1, wherein a shape of the end cap is a half dome.

8. The apparatus of claim 1, wherein the textured outer surface comprises a plurality of dimples.

9. The apparatus of claim 1, wherein the textured outer surface comprises a non-uniform pattern.

10. The apparatus of claim 1, wherein the textured outer surface comprises a film adhered to an outer surface of the end cap.

11. The apparatus of claim 1, wherein the textured outer surface is formed by pressing a pattern into an outer surface of the end cap.

12. A radome with reduced wind load comprising:
a main body having a vertical length and a cross section comprising a width and a depth; and
a pair of end caps disposed at opposite ends of the vertical length of the main body to cover openings at a top and bottom end of the main body;
wherein at least one of the pair of end caps comprises a textured outer surface and corners that are rounded with respect to a vertical plane of the radome to have a radius of at least 10 mm.

13. The radome of claim 12, wherein the corners comprise:
first corners along the width of the end cap and having a first radius; and
second corners along the depth of the end cap and having a second radius; wherein the first radius is smaller than the second radius.

14. The radome of claim 13, wherein the first radius is approximately equal to half the depth and the second radius is approximately equal to half the width.

15. The radome of claim 12, wherein the main body and the pair of end caps comprise a dimpling pattern disposed on a majority of the outer surface of the main body and the pair of end caps.
